(19) United States
(12) Patent Application Publication
(10) Pub. No.: US 2009/0223685 A1
(43) Pub. Date: Sep. 10, 2009

(54) SOIL AERATOR DEVICE

(76) Inventor: Guadalupe Garcia, Santa Monica, CA (US)

Correspondence Address: NW-IP-LAW, 6039 E. Grant RD., Tucson, AZ, 85712, US

(21) Appl. No.: 12/045,008

(22) Filed: Mar. 9, 2008

(51) Int. Cl. A01B 45/02

(52) U.S. Cl. 172/22

(57) ABSTRACT

The present invention features an aerator comprising an elongated base component with an upper surface and a lower surface, a handle spaced apart from the elongated base component, a U-shaped bracket connected to the handle and also connected to the elongated base component. In some embodiments, a first arm and second arm of the U-shaped bracket connecting to the upper surface of the elongated base component and a region between the two shoulders of the U-shaped bracket connecting to the handle.

### BACKGROUND OF THE INVENTION

The present invention features a hand tool that would effectively and efficiently plug the edges of a lawn or turf during an aeration task.

### BRIEF DESCRIPTION OF THE DRAWINGS

FIG. 1 shows a perspective view of the present aerator.

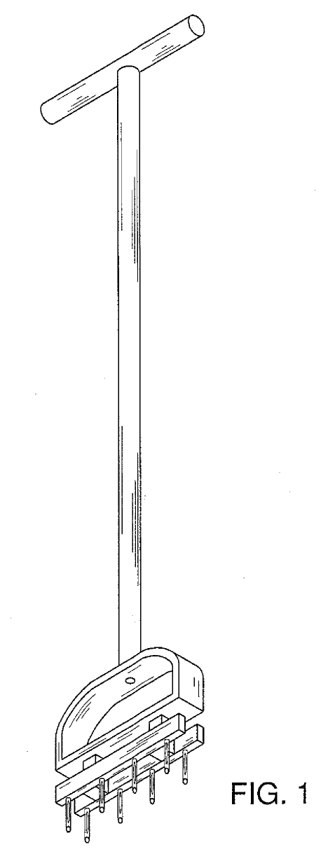

FIG. 2A shows a front view of the present aerator.

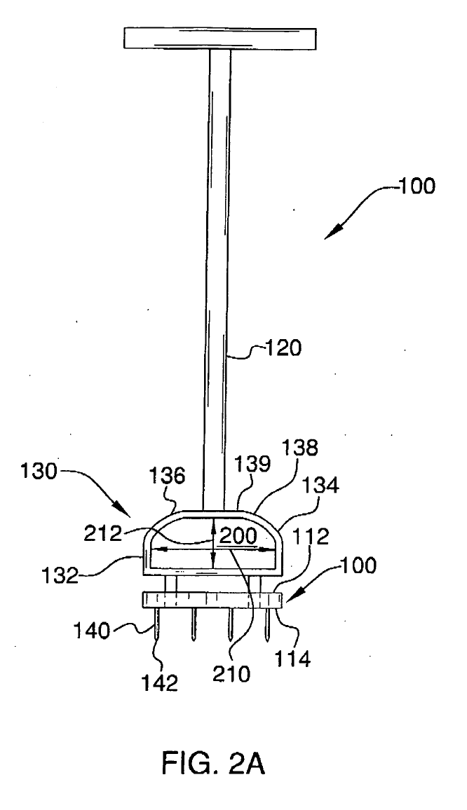

FIG. 2B shows an insert close up of the tines.

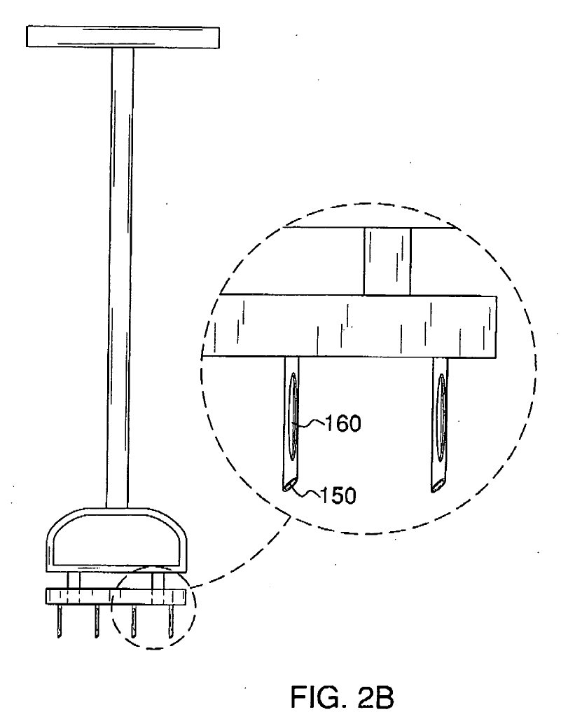

### DESCRIPTION OF PREFERRED EMBODIMENTS

The present invention features an aerator 100 comprising an elongated base component 110 with an upper surface 112 and a lower surface 114, a handle 120 spaced apart from the elongated base component 110, a U-shaped bracket 130 connected to the handle 120 and also connected to the elongated base component 110. In some embodiments, a first arm 132 and second arm 134 of the U-shaped bracket 130 connecting to the upper surface 112 of the elongated base component 110 and a region between the two shoulders 136/138 of the U-shaped bracket 130 connecting to the handle 120.

In some embodiments, a plurality of hollow tines 140 is attached to the elongated base component 110 wherein each tine 140 has an earth-piercing end such that the earth-piercing end 142 is downwardly directed from the elongated base component 110. The hollow tines 140 further comprising an entry hole 150 at the earth piercing end and an exit hole 160 on the side of the tine wherein dirt enters the entry hole and exits the exit hole.

In some embodiments, the elongated base component comprises a first bar 111A and a second bar 111B, each with an upper and a lower surface making up the upper and lower surface of the elongated base component.

In some embodiments, one or more of the components of the present invention may be constructed from wood. In some embodiments, one or more of the components of the present invention may be constructed from a metal (including galvanized metal).

In some embodiments, the handle comprises a T-shaped, wherein a user can hold on to the top part of the T. In some embodiments, the handle has a length of about 11.5 inches to about 13 inches, preferably about 12 inches.

In some embodiments, the U-shaped bracket 130 forms a cavity 200 for a user to insert one foot or both feet therein to step onto the elongated base component 110. In some embodiments, the distance from the first arm 132 to the second arm 134 is about 6 inches to about 7 inches, preferably about 6.5 inches. In some embodiments, the distance from the upper surface of the elongated base component to the region between the shoulders 139 of the U-shaped bracket is about 3 inches to about 3.5 inches, preferably about 3.25 inches.

The tines 140 may comprise a cross section having a circular shape, square shape, rectangular shape, or oval shape. The cross-sectional size of the tine may be any size deemed appropriate by one of ordinary skill, for use in aerating the earth.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention it will be readily apparent to those skilled in the art that modifications may be made thereto which do not exceed the scope of the appended claims. Therefore, the scope of the invention is only to be limited by the following claims.

1. An aerator comprising:
(a) an elongated base component with an upper and a lower surface;
(b) a handle spaced apart from the elongated base component;
(c) a U-shaped bracket connected to the handle and also connected to the elongated base component, with a first arm and second arm of the U-shaped bracket connecting to the upper surface of the elongated base component via a connecting bar, and a region between the two shoulders of the U-shaped bracket connecting to the handle; and
(d) a plurality of hollow tines in at least one row attached to the elongated base component wherein each tine has an earth-piercing end such that the earth-piercing end is downwardly directed from the elongated base component, wherein the earth-piercing end is further beveled, the hollow tines further comprising an entry hole at the earth piercing end and an exit hole on the side of the tine wherein dirt enters the entry hole and exits the exit hole.

2. The aerator of claim 1 wherein the elongated base component comprises a first bar and a second bar, each with an upper and a lower surface making up the upper and lower surface of the elongated base component.
